(19) United States
(12) Patent Application Publication
(10) Pub. No.: US 2003/0202494 A1
(43) Pub. Date: Oct. 30, 2003

(54) Establishing an ad hoc network

(76) Inventors: Paul C. Drews, Gaston, OR (US); Casey S. Bahr, Hillsboro, OR (US); Sushim Mandal, Porland, OR (US); Joel D. Schuetze, Forest Grove, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/133,101

(22) Filed: Apr. 26, 2002

(51) Int. Cl. H04Q 7/24

(52) U.S. Cl. 370/338; 370/349

(57) ABSTRACT

The claimed subject matter relates to establishing and ad hoc network and, more particularly, to the establishment of an ad hoc network utilizing a node and a plurality of nodelets.

### BACKGROUND

1. Field

The claimed subject matter relates to establishing an ad hoc network and, more particularly, to the establishment of an ad hoc network utilizing a node and a plurality of nodelets.

2. Background Information

In order for a mobile terminal to connect to a wireless network, the mobile terminal is typically required to be within range of an access point (which may, in some cases, be permanently located). Because each access point has a substantially fixed communication range, a single access point may not provide wireless network access to a large area. Therefore, in order to increase the area in which network access is provided, one often adds additional access points or provides access points with greater communication ranges than the original access points.

Either option for increasing the area in which the network is functional is expensive. Providing additional access points, often referred to as “antenlas” or “towers,” causes the network provider to incur the cost of the physical access point devices, and possibly an additional cost for renting or leasing the physical space the access point occupies. Increasing the communication range of the access point is often expensive due to the research cost in developing an access point with increased range and the ongoing cost of providing additional power to the access point. Similar issues may exist if the network is established via physically coupled devices. A need, therefore, exists for an improved system or technique for establishing an ad hoc network.

### BRIEF DESCRIPTION OF THE DRAWINGS

Subject matter is particularly pointed out and distinctly claimed in the concluding portions of the specification. The claimed subject matter, however, both as to organization and the method of operation, together with objects, features and advantages thereof, may be best understood by a reference to the following detailed description when read with the accompanying drawings in which:

FIG. 1 is a block diagram illustrating an ad hoc network established in accordance with the claimed subject matter;

FIG. 2 is a block diagram illustrating an ad hoc network established in accordance with the claimed subject matter;

FIG. 3 is a flowchart diagram illustrating establishing and utilizing an ad hoc network in accordance with the claimed subject matter;

FIG. 4 is a flowchart diagram illustrating establishing an ad hoc network in accordance with the claimed subject matter;

FIG. 5 is a block diagram illustrating an ad hoc network established in accordance with the claimed subject matter;

FIG. 6 is a block diagram illustrating an ad hoc network established in accordance with the claimed subject matter;

FIG. 7 is a block diagram illustrating an ad hoc network established in accordance with the claimed subject matter;

FIG. 8 is a block diagram illustrating an ad hoc network established in accordance with the claimed subject matter; and

FIG. 9 is a flowchart diagram illustrating technique to utilize an ad hoc network established in accordance with the claimed subject matter.

### DETAILED DESCRIPTION

In the following detailed description, numerous details are set forth in order to provide a thorough understanding of the present claimed subject matter. However, it will be understood by those skilled in the art that the claimed subject matter may be practiced without these specific details. In other instances, well-known methods, procedures, components, and circuits have not been described in detail so as to not obscure the claimed subject matter.

As used herein, a node is a device that is permanently or primarily located in a fixed place and provides access to a network. Examples of such a network may include networks, such as, for example, the Internet, the telephone system, or a cable television network. While the illustrated embodiments of the claimed subject matter deal mainly with access to the Internet, one skilled in the art will understand that various embodiments may be easily adapted to interface with a variety of networks and that the claimed subject matter is not limited to any particular network. One skilled in the art will also understand that a node may not be directly coupled to a network backbone; a node may merely serve as a gateway to another network, which in turn provides access to a network backbone.

As used herein, a nodelet is a device that is often not permanently located in a fixed place and utilizes a node to gain access to the network backbone. Examples of such a device may include devices, such as, for example, cellular telephones, handheld computers, personal digital assistants, media players and mobile computers. However, one skilled in the art will understand that these are merely a few non-limiting examples of Such a device. Nodelets often, but not necessarily, serve as interactive user terminals to the network. A nodelet may connect to a node via a wireless protocol. Such a wireless protocol may involve technologies, such as, for example, radio frequency communication or infrared frequency communication. However, one skilled in the art will realize that other wireless technologies utilizing communication via other frequencies may be utilized.

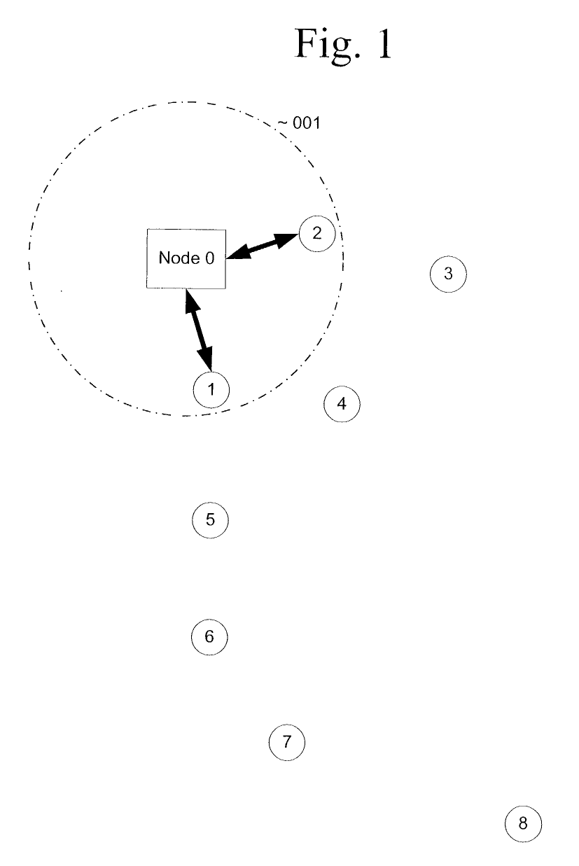

FIG. 1 is a block diagram illustrating an embodiment of the claimed subject matter. Node 0 may be established in a fixed place and provides access to a network backbone. In a specific example, to which the claimed subject matter is not limited, node 0 may be situated in a public place, such as, for example, a coffee house. In this specific example, node 0 may provide access to the Internet to members of the public. Of course, one skilled in the art will realize that a node may be located in a variety of locations, both public and private, and may provide access to a variety of networks.

Node 0 may utilize a wireless protocol that has a limited range 001. In the specific example above, the coffee house node may utilize a protocol, which is substantially in compliance with, for example, the IEEE 802.11b wireless local area network (WLAN) standard. Supplement to 802.11-1999, Wireless LAN MAC and PHY specifications: Higher speed Physical Layer (PHY) extension in the 2.4 GHz band, IEEE Std. 802.11b-1999 (hereafter “802.11b”). In another embodiment of this specific example, the coffee house node may utilize a protocol, which is substantially in compliance with, for example, any standard derived or supplemental to the IEEE 802.11 wireless local area network (WLAN) standard (hereafter, “the 802.11 standard or specification family”). Standards for Information Technology—Telecommunications and Information Exchange between Systems—Local and Metropolitan Area Network—Specific Requirements—Part 11: Wireless LAN Medium Access Control (MAC) and Physical Layer (PHY) Specifications, ANSI/IEEE Std. 802.11-1999 (hereafter “802.11”).

Of course, one skilled in the art will understand that these are merely a few specific examples of wireless protocols and that a variety of protocols may be used, such as for example, a protocol which utilizes frequencies in the infrared spectrum, a protocol which utilizes frequencies in the radio spectrum, a protocol substantially in compliance with those typically used for cellular telephone communication or, in yet another example, a protocol substantially in compliance with the Bluetooth wireless specification. Specification of the Bluetooth System, Bluetooth SIG ver. 1.1, Feb. 22, 2001 (hereafter, “Bluetooth”). Of course, one skilled in the art will realize that these are merely a few non-limiting examples and other communication protocols may also be used.

Because the wireless protocol utilized by node 0 has a limited range 001, it may only communicate with nodelets that are within that limited range. In the embodiment illustrated by FIG. 1, only nodelets 1 and 2 are within the limited communication range of node 0 and may communicate with node 0. In this illustration, it is assumed that the limited communication ranges of node 0 and nodelets 1-8 are equidistant. One skilled in the art will realize that is merely a simplification made for illustrative purposes and the claimed subject matter is in no way limited to embodiments where all nodelets and/or nodes have equidistant communication ranges.

In the specific example above, nodelets 1-8 may be mobile devices, such as, for example, notebook computers, cellular telephones, personal digital assistants, or media players, which might utilize a network connection to provide access to media. However, one skilled in the art will understand that these are merely a few non-limiting examples that is not limiting on the claimed subject. For the specific example above, which the claimed subject matter is not limited by, nodelets 1-8 will be considered smart cellular telephones that are capable of accessing the Internet.

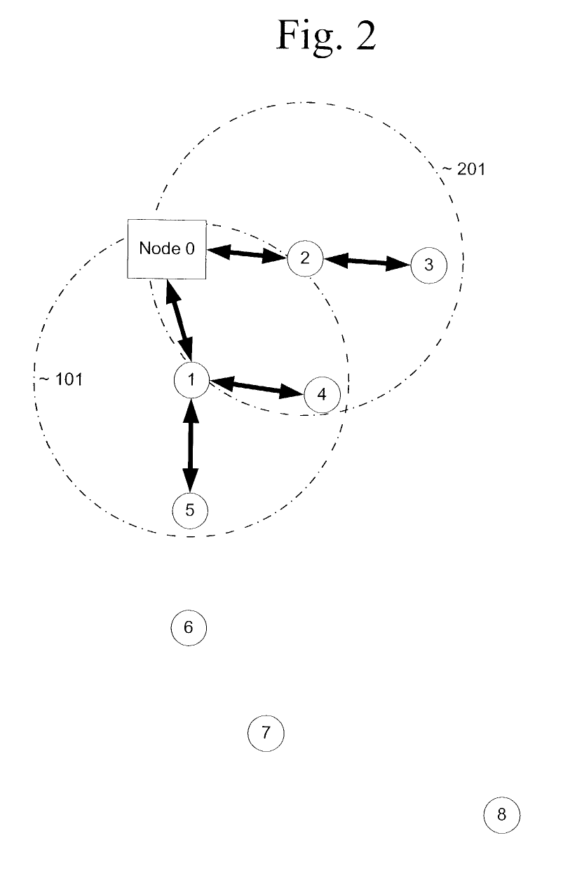

FIG. 2 is a block diagram illustrating an embodiment of the claimed subject matter. FIG. 2 builds upon the embodiment illustrated in FIG. 1. Nodelets 1 and 2 are in the communication range of node 0, and, therefore, may be in communication with node 0. Nodelets 3-8 are not within the communication range of node 0, and, therefore, may not be in direct communication with node 0. As previous stated, for illustrative purposes it is assumed that all nodelets and nodes have equidistant communication ranges; however, the claimed subject matter is not limited to this case. Nodelet 1 has a communication range 101, which allows communication with node 0, nodelet 5 and nodelet 4. Nodelet 2 has a communication range 201, which allows communication with node 0, nodelet 3, and nodelet 4.

In the specific example above, node 0 may be considered to be placed in the north-east corner of a square coffee house. This node may have a communication range which extends to just over the middle section of the coffee house. If a patron carrying a smart cellular phone, represented by nodelet 1, sits in the middle of the coffee house, the patron's cellular phone may be in direct communication with node 0. A second patron, sitting in the south-west corner of the coffee house may have a smart cellular phone, represented by nodelet 5. Because the second patron's cellular phone is outside the communication range of node 0, it may not access the network backbone. However, the second patron's cellular phone, node 5, may be in range of the first patron's cellular phone, node 1. One skilled in the art will realize that this is merely a specific illustrative example, and other embodiments of the claimed subject matter are possible.

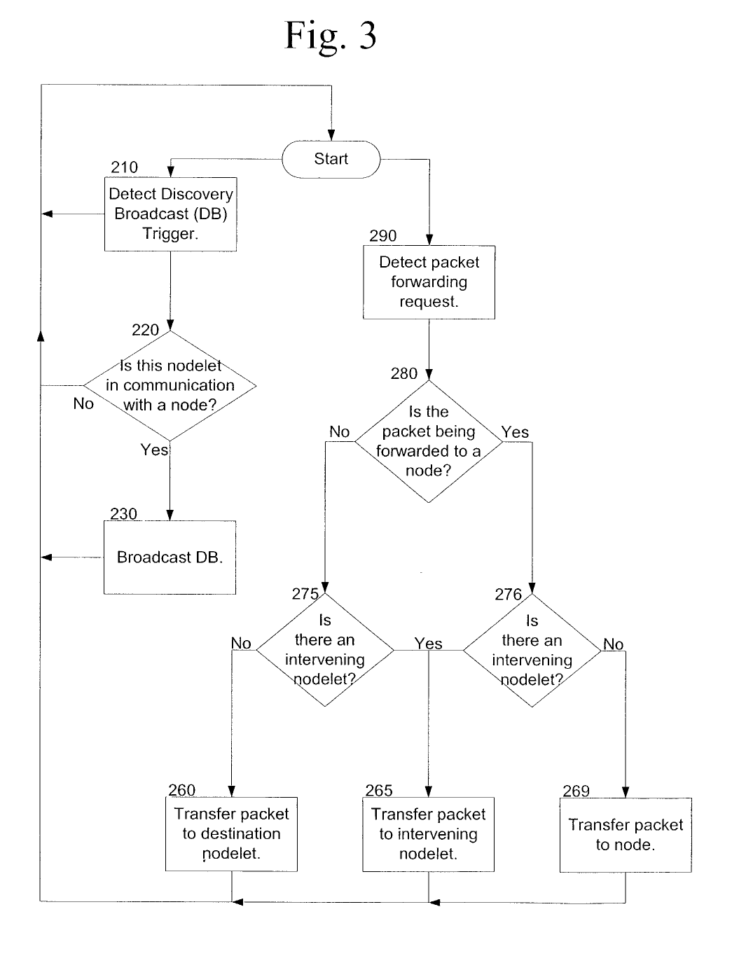

FIG. 3 illustrates an embodiment of a technique that nodelets 1 and 2 may utilize in order to establish an ad hoc network allowing communication between node. 0 and nodelets 3-5. As represented by action 210, nodelet 1, or respectively nodelet 2, may detect a trigger that initiates the transmission of a discovery broadcast. A discovery broadcast, in this context, is a transmission, which allows other nodelets to establish themselves within an ad hoc network. One skilled in the art will realize that a variety of triggers may be utilized for this purpose. Such triggers may involve, for example, a timer, a user configured parameter, a request signal from another device, a request from the network, or a signal derived from the status of the network. However, these are merely a few non-limiting examples that the claimed subject matter is not limited.

Action 220 illustrates that the nodelet may not transmit a discovery broadcast if it is not in communication with a node. One skilled in the art will realize that other gating factors may limit the transmission of a discovery broadcast, and that this is merely one example.

Action 230 illustrates the transmission of the discovery broadcast. In the embodiment illustrated in FIG. 2, a discovery broadcast may be an omni-directional transmission that allows nodelets, which are not in communication with the node, to establish communication with the node. Such a discovery broadcast may contain many forms of information, such as, for example, the number of nodelets between (in a network topology sense) the node and the broadcasting nodelet, the throughput of the communication between the nodelet and the node, a marker that is related to the quality of service of the communication between broadcasting nodelet and the node, or a unique identifier related to the nodelet. One skilled in the art will understand that such a discovery broadcast may take many forms and that the examples above are merely a few non-limiting instances. For example, a discovery broadcast need not be omni-directional. One skilled in the art will further understand that a quality of service marker may include many elements, such as, for example, the nodelet's reliability in properly forwarding data; however, this is merely one example of many elements that may be included in a particular form of a quality of service marker. In another embodiment of the claimed subject matter, the discovery broadcast may be a series of transmissions between the nodelet in communication with the node and an unconnected nodelet. One skilled in the art will understand that the discovery broadcast may take a variety of forms.

In the non-limiting specific example above, the first patron's smart cellular phone, nodelet 1 of FIG. 2, may be configured to transmit a discovery broadcast every (to choose a non-limiting arbitrary number for illustrative purposes) 60 seconds. Of course, one-skilled in the art will realize that a timer set to any measurement of time is merely one form of trigger that may be utilized to regulate the transmission of a discovery broadcast and that this is merely an illustrative example. At the designated time, nodelet 1 may transmit a discovery broadcast in order to inform any other nodelets that nodelet 1 is in communication with node 0, that it is in direct communication with node 0, and that it has a unique identifier, which may be, in this example, 1. Once again, one skilled in the art will understand that this is merely a specific illustrative example and that the claimed subject matter is not limited to discovery broadcasts which contain any one set of information.

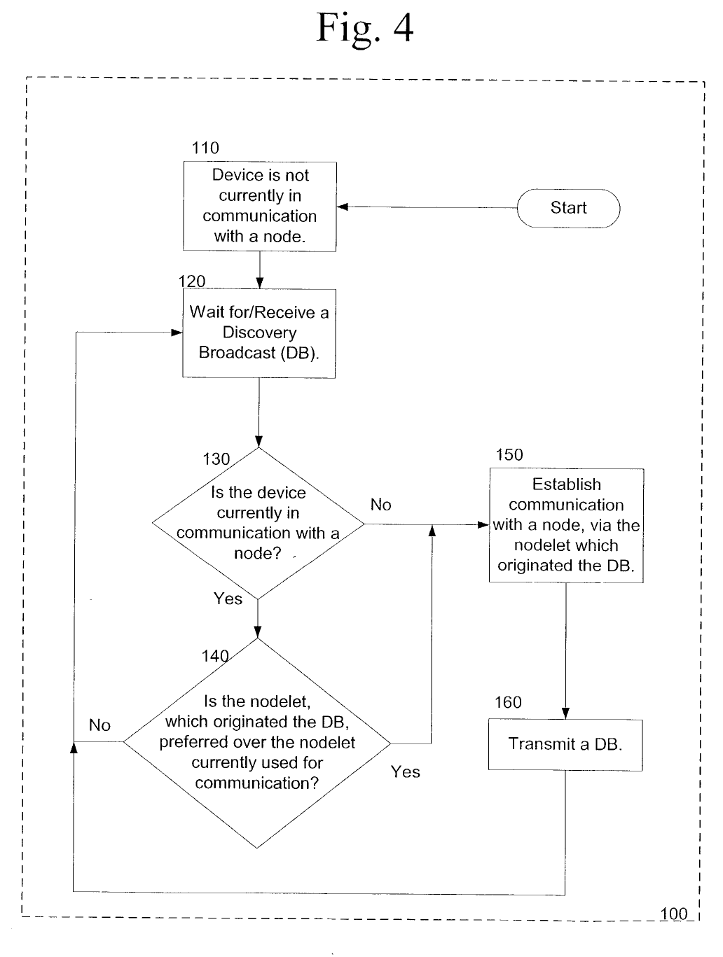

FIG. 4 illustrates a technique or series of actions that a nodelet, which is not currently in communication with a node, i.e., an unconnected nodelet, may take in order to establish an ad hoc network in accordance with the claimed subject matter. Action 110 illustrates that a nodelet will often start in a position where it is not in communication with a node. Action 120 illustrates that this nodelet may wait until it receives a discovery broadcast. As above, one skilled in the art will understand that a discovery broadcast may take many forms and in some of those forms the discovery broadcast may be initiated by an unconnected nodelet. However, in the embodiment illustrated by FIG. 4, and the specific non-limiting example above, the discovery broadcast is initiated by a nodelet that is already in communication with a node.

Action 150 illustrates that an unconnected nodelet may establish communication with a node via the nodelet that originated the discovery broadcast. Because the nodelet that originated the discovery broadcast is between (in a network topology sense) the unconnected nodelet and the node, it is referred to as an “intervening nodelet.” One skilled in the art will realize that establishing communication with a node may take many forms. For example, establishing communication may involve transmitting a broadcast to the node that registers the new nodelet on the network or, conversely, the newly connected nodelet may internally note that it is currently established on the network and postpone transmission of data to the node until the nodelet desires access to the network backbone. One skilled in the art will realize that these are merely two alternative techniques for establishing communication with the node and that other techniques may be used.

Action 160 illustrates that upon establishing communication with a node, via the nodelet which originated the discovery broadcast, the nodelet may in turn transmit a new discovery broadcast. This may allow additional nodelets to establish a connection to the node via the newly connected nodelet. Of course one skilled in the art will understand that other techniques may be used to perpetuate the ad hoc network and that this is merely one example.

In the specific example above, the second patron's smart cellular phone, nodelet 5 of FIG. 2, is not in direct communication with node 0. As previously described, the first patron's cellular phone, nodelet 1, is in communication with node 0 and is transmitting discovery broadcasts. The second patron's smart cellular phone is within direct communication range of the first patron's cellular phone and receives the discovery broadcast. Upon receiving the discovery broadcast, nodelet 5 establishes communication between itself and node 0, via nodelet 1. The first patron's cellular phone is now considered an intervening nodelet in regards to the second patron's cellular phone. In this example, establishing communication between nodelet 5 and node 0 is done by registering nodelet 1 as an intervening nodelet with nodelet 5 and withholding the transmission of data to node 0 until access to the Internet is desired. The second patron is now able to access the Internet using his smart cellular phone, which is in communication with node 0 via nodelet 1. Similar actions, as illustrated regarding nodelets 1 and 5, may be performed for nodelets 2 and 3, respectively. One skilled in the art will understand that this is merely one detailed example of an embodiment of the claimed subject matter and many other embodiments are possible.

FIG. 2 also illustrates an embodiment where nodelet 4 is within both nodelet 1's communication range 101 and nodelet 2's communication range 201. FIG. 4 illustrates actions, which may be taken when a particular nodelet receives discovery broadcasts from more than one nodelet. Action 140 illustrates that, when a nodelet receives substantially simultaneous discovery broadcasts or a discovery broadcast when it is already in communication with the node, the nodelet must select which broadcasting nodelet to utilize for communication with the node. A nodelet might prefer one broadcasting nodelet over another utilizing many factors, such as, for example, the signal strength of the broadcasting nodelets, the number of intervening nodelets associated with the broadcasting nodelets, the communication range of the nodelets, the network throughput of the broadcasting nodelets, a quality of service marker associated with the broadcasting nodelets, or the status of prior communications with one or more of the broadcasting nodelets. One skilled in the art will understand that these are merely a few non-limiting examples of factors, which may be considered when choosing which nodelet to communicate with. One skilled in the art will understand that the factors to be considered may be statically, semi-dynamically, or dynamically configured. In the embodiment illustrated by FIG. 2, nodelet 4 preferred to communicate with node 0 via nodelet 1.

In the specific example above, the second patron, whose smart cellular phone is represented by nodelet 5 of FIG. 2, may wish to access the Internet. To do so nodelet 5 may request that nodelet 1 forward a packet to node 0. In this context, a packet is a quantum of data that is transmitted across the network. One skilled in the art will realize that a packet may take many forms depending upon the communication protocol used by the network. For example, the protocol may refer to a quantum of data as a stream, burst, or packet. In addition, these quanta may be broken into discrete units or, conversely, an entire transmission may involve a continuous flow of data; however, one skilled in the art will understand that, in this context, any transmission of data in whole or in part is referred to as a packet.

FIG. 3 illustrates an embodiment that includes a technique for forwarding packets from a source nodelet, in this example, nodelet 5 of FIG. 2, to a node. Action 290 of FIG. 3 illustrates the detection, by an intervening nodelet, in this example, nodelet 1 of FIG. 2, of a request to forward a packet. Action 280 of FIG. 3 illustrates that the intervening nodelet may check to determine the final destination of the packet within the ad hoc network. Specifically, this may involve determining if the packet is being forwarded to a node or a nodelet.

At this time, the intervening nodelet may check that at least a partial route exists between the intervening nodelet and the packet's destination within the ad hoc network.

One skilled in the art will understand that this action may take many forms, such as, for example, the routing information may be stored within the intervening nodelet, the routing information may be stored within the packet, the intervening nodelet may query a central source for routing information, or the intervening nodelet may assume that the node or next intervening nodelet it is in communication with is the proper recipient of the packet. One skilled in the art will realize that this routing information is highly influenced by the communication protocol used by the nodelets and is not limited to any particular embodiment of the claimed subject matter.

Also, at this time, the intervening nodelet may take the opportunity to build a routing table that would allow future packets from the node to the current source nodelet to be forwarded properly. One skilled in the art will understand that this example is merely one embodiment of the claimed subject matter. One skilled in the art will also understand that such a routing table could be established, for example, only the first time a packet is sent from a nodelet to the node, or, at the other end of the spectrum, the table may be updated every time a packet is sent from a nodelet to the node. However, these are merely non-limiting examples of particular embodiments of the claimed subject matter.

If, as in the specific example, a packet is being sent from a source nodelet to the node, action 276 illustrates that, if there are multiple intervening nodelets between (in a network topology sense) the source nodelet and the node, the current intervening nodelet will forward the packet to the next intervening nodelet. This is illustrated by action 265. One skilled in the art will understand that this forwarding process may be repeated for each intervening nodelet. Alternately, if there are no intervening nodelets, the packet may be forwarded directly to the node. This is illustrated by action 269.

In the specific coffee house example, the second patron's access of the Internet may create a request, by nodelet 5 of FIG. 2, to forward a packet to node 0. This forwarding request may be received by nodelet 1. Nodelet 1 will then forward this packet, directly to node 0. In this specific example, nodelet 1 may create a routing table, which informs it that nodelet 5 is in direct communication with nodelet 1. One skilled in the art will understand that this coffee house example is merely a particular embodiment of the claimed subject matter and many other embodiments are possible.

FIG. 3 also illustrates the actions, which may be performed by an intervening nodelet when a packet is forwarded from a node to a destination nodelet. The set of actions is very similar to actions 290, 280, 276, 265, and 269 described above. In this instance, if the intervening nodelet is in direct communication with the destination nodelet, the packet may be transferred to the destination nodelet, as illustrated by action 260. Actions 275 and 265 illustrate that, if the intervening nodelet is not in direct communication with the destination nodelet, the packet may be forwarded to the next intervening nodelet. One skilled in the art will understand that the same variations and issues as discussed in the source nodelet to node case, previously described, apply.

To continue the specific coffee house example, if a web page is being delivered to the second patron's smart cellular phone, as represented by nodelet 5 of FIG. 2, nodelet 0 may broadcast a request to forward a particular packet to nodelet 5. In this example, the request may be broadcast in an omni-directional fashion and be received by both nodelets 1 and 2. One skilled in the art will understand that other means of making the request may be utilized and this is merely one example. Nodelet 2 may find that it knows of no proper route to nodelet 5 and refuse to forward the packet. Nodelet 1 may examine the routing table that was built when nodelet 5 transmitted to node 0, and because nodelet 1 has a route, accept the forwarding request. One skilled in the art will realize that other communication protocols may be used and that this is only one specific illustrative example of an embodiment of the claimed subject matter. Nodelet 1 may then forward the packet to nodelet 5. The second patron may then be able to view the web page he previously requested. One skilled in the art will understand that other forms of data may be received and placed on the network and that this is purely an illustrative example.

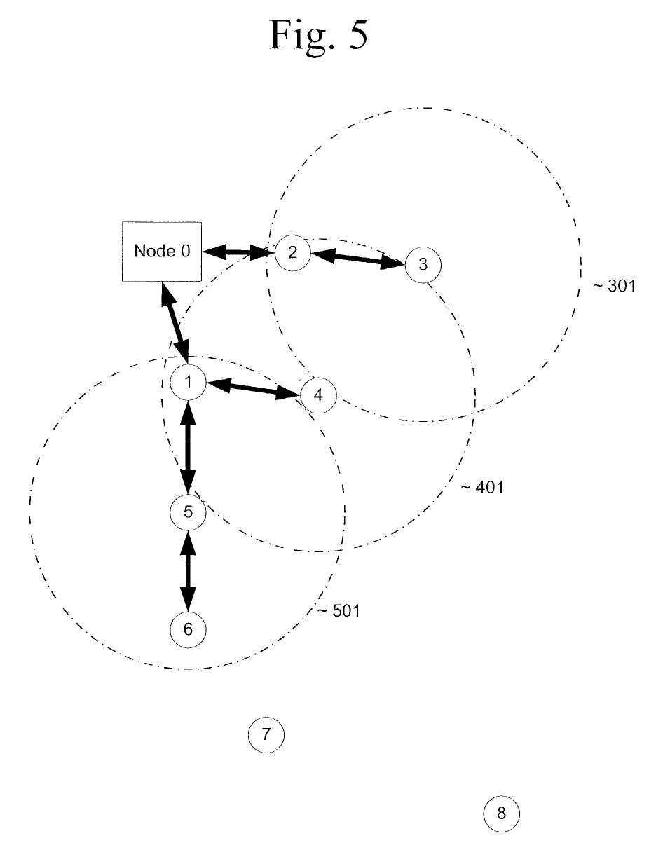

FIG. 5 illustrates an embodiment of the claimed subject matter where the actions and system illustrated in FIG. 2 may be repeated and extended. Nodelet 3 has a communication range 301. Nodelet 4 has a communication range 401. Nodelet 5 has a communication range 501. Nodelets 3-5 may make discovery broadcasts as illustrated by actions 210-230 of FIG. 3. No additional unconnected nodelets are found within the communication ranges of nodelets 3 or 4. Therefore, nodelets 3 and 4 may be referred to as the most distant nodelets of their portion of the network. Nodelet 6 is an unconnected nodelet and is within the communication range of nodelet 5. In the specific coffee house example, nodelet 6 may be considered a third patron who is sitting at an Outside table.

Therefore, the actions illustrated in FIG. 4, and described above, may be performed in order to establish communication between nodelet 6 and node 0, via nodelets 5 and 1. Nodelets 5 and 1 are considered intervening nodelets in regard to nodelet 6. One skilled in the art will understand that this is merely one embodiment of the claimed subject matter and the same variations and concerns described above regarding FIG. 2 are present in FIG. 5.

In addition, nodelet 6 of FIG. 5, may send packets to and receive packets from node 0 in much the same manner as described above in regards to nodelet 5. In the embodiment illustrated by FIG. 5, nodelet 1 would forward packets from node 0 and destined to nodelet 6, to the intervening nodelet 5. This is illustrated by actions 290, 280, 275, and 265 of FIG. 3. In turn, nodelet 5 of FIG. 5 would forward these packets to destination nodelet 6. This is illustrated by actions 290, 280, 275, and 260 of FIG. 3. Likewise, as illustrated by actions 290, 280, 276, and 265 of FIG. 3, nodelet 5 of FIG. 5 would forward packets, from nodelet 6 and destined for node 0, to the intervening nodelet 1. Nodelet 1 would then forward the packets to node 0. One skilled in the art will understand that this is merely one embodiment of the claimed subject matter and the same variations and concerns described above are present in this embodiment.

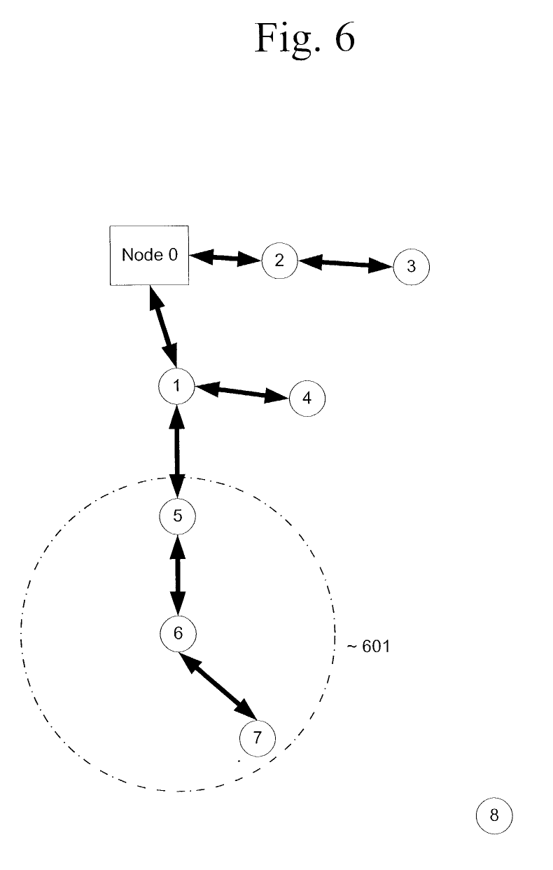

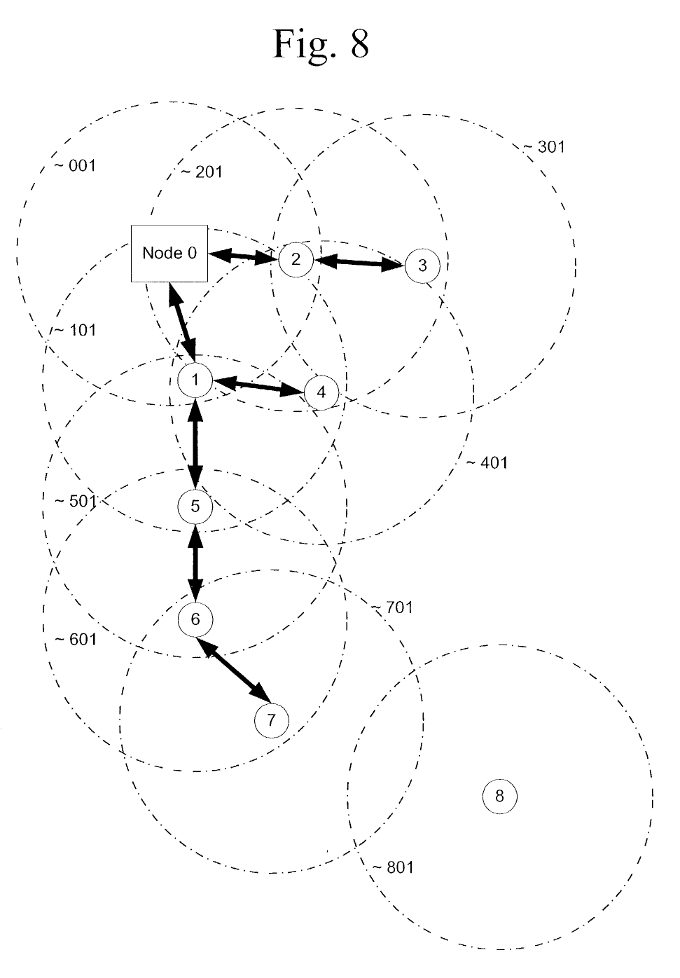

FIG. 6 illustrates and embodiment that shows the further extendibility of the system and techniques previously discussed. In this particular embodiment, nodelet 6 is an intervening nodelet in regards to nodelet 7. One skilled in the art will understand that this network may be further extended. One skilled in the art will also understand that, as illustrated by the embodiment of FIG. 8, the topology of such a network need not be symmetrical or take any particular predefined shape.

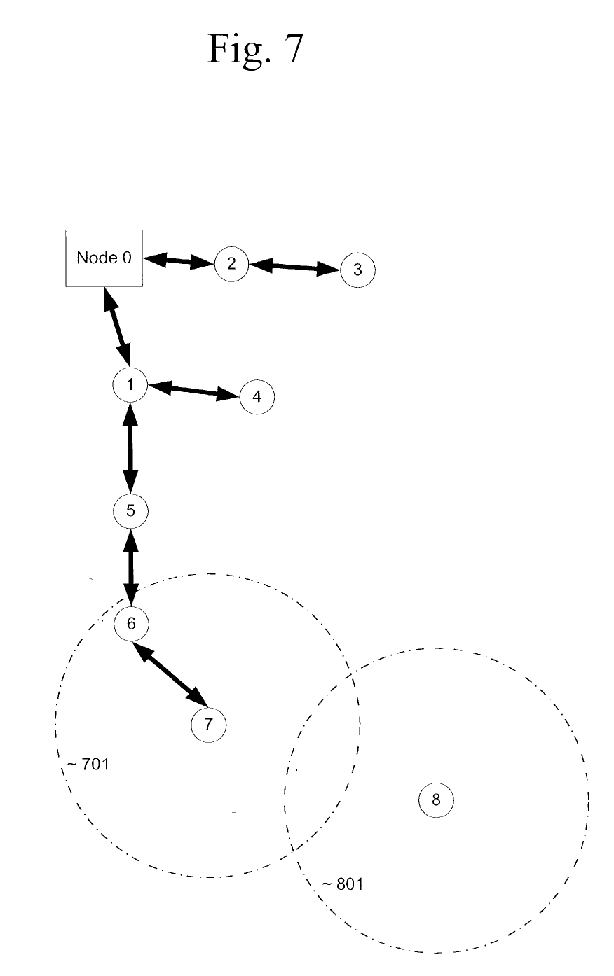

FIG. 7 illustrates an embodiment of the claimed subject matter where a nodelet is too far out of communication range to establish communication with the node. In this example, nodelet 8 is outside of nodelet 7's communication range 701. Therefore, it is not able to move beyond action 110 of FIG. 4. In order to connect to the network and establish communication with the node, the owner of node 8 will typically move within the communication range of one of the established nodelets or the node. One skilled in the art will understand that, if an established nodelet moves out of range of one of the established nodelets or the node, the nodelet may lose a connection with the network. One skilled in the art will understand that the techniques for gracefully disconnecting from a network are well known.

In one embodiment, FIG. 8 may illustrate a system, which includes a node, node 0, and a number of nodelets, nodelets 1-7, that are in communication with the node. Specifically, nodelets 3-7 are in communication with node 0 via at least intervening nodelets 1 or 2. Each nodelet in the embodiment, illustrated by FIG. 8, may be capable of, during operation, performing the actions shown in FIGS. 3 and 4. Of course, one skilled in the art will understand that other embodiments may be created that produce a system in compliance with the claimed subject matter. One skilled in that art will also understand that any communication conducted amongst the nodelets and nodes illustrated in FIGS. 1, 2, and 5-8 may be conducted in the secure fashion. Also, one skilled in the art will understand that communication between nodelets, with or without the utilization of node 0, is contemplated. One skilled in the art will further understand that a system may involve multiple nodes. Furthermore, one skilled in the art will understand that while a substantially wireless network is illustrated in FIGS. 1, 2, and 5-8, a particular embodiment of the claimed subject matter may contain a mix of wired and wireless technologies, or, alternative, an entirely wired network.

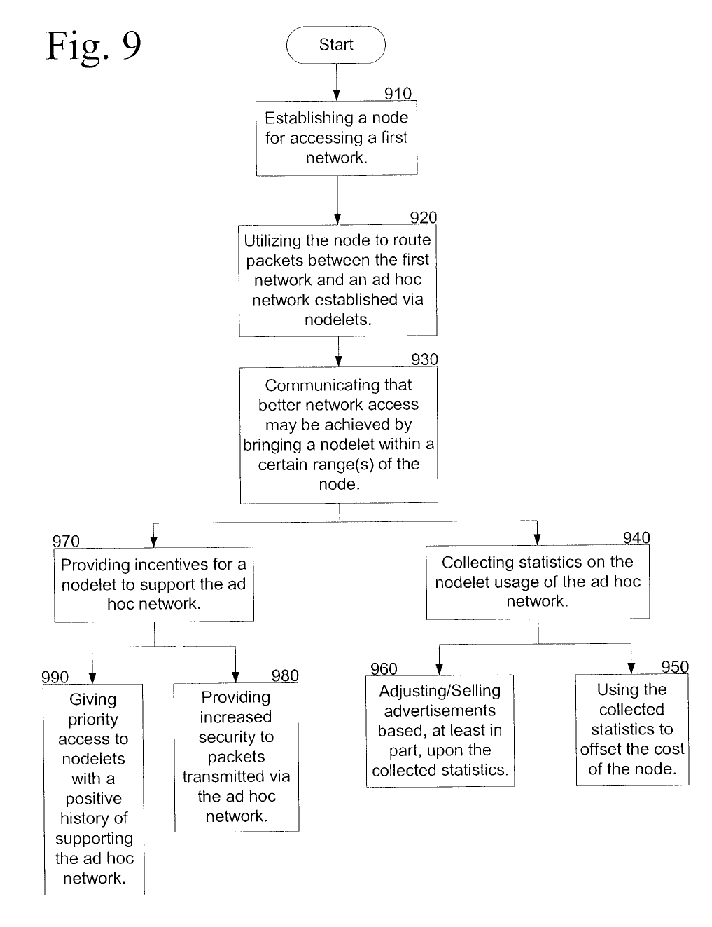

FIG. 9 illustrates a technique or series of actions that may be used to facilitate a business incorporating the claimed subject matter. Action 910 illustrates that a node for accessing a first network may be established in a particular location. This location may be a public place, such as, for example, a restaurant, cafe, or a bookstore. Of course, one skilled in the art will understand that these are merely a few non-limiting examples and that a number of private places may also be used. Action 920 illustrates that this node may be used to route packets between the first network and an ad hoc network. One skilled in the art will understand that an example of a first network, may include access to a network backbone, such as, for example, the Internet. Such an ad hoc network may be established utilizing a number of nodelets. The establishment of one embodiment of such a network has been detailed above. Of course, one skilled in the art will understand that other ad hoc network schemes may be used.

Action 930 illustrates that a the owner of the node or location where the node is physical located, such as, a business, may communicate, via, for example, advertising, that better network access may be achieved by bringing a nodelet with in a certain range, or ranges, of the node. One skilled in the art will understand that, used herein, the term “business” refers to both the full spectrum of commercial enterprises (from sole proprietorship to partnership to corporation), and a number of non-commercial or nonprofit associations. In a specific example, the coffee house, as described above, may place a node within the coffee house and advertise that better network access may be achieved if patrons come with the coffee house.

One skilled in the art will realize that a business may do this for many reasons, such as, for example, a belief that if the patrons are lured into the store by network access, the patrons will purchase more products or services. Of course, one skilled in the art will conceive of additional reasons a business may provide network access to the business' patrons. One skilled in the art will also realize that a business may either charge for network access or provide that access for free.

Action 940 illustrates that a business may collect statistics on a nodelet's usage of the ad hoc network. One skilled in the art will understand that a variety of statistics may be collected, such as, for example, the amount of time spent by a nodelet within a certain range of the node, the marketing demographics of the user of the nodelet, the content accessed by the nodelet, the support provided by the nodelet for the ad hoc network, and the location of the nodelet. Of course, one skilled in the art will further understand that these are merely a few non-limiting examples of statistics that may be collected from the ad hoc network. In this context, support of the ad hoc network may include actions or services that promote the growth, development and maintenance of the ad hoc network, and are further described in relation to Action 970.

Action 960 illustrates that a business may adjust or sell marketing and advertising based, at least in part, upon the collected statistics. For example, the coffee house may change the advertisements for coffee and the types of coffee or other products sold based, at least in part upon the collected statistics. In another example, the coffee house may use the collected statistics to sell advertising space within the coffee house to other businesses. In yet a third example, the coffee house may turn the collected statistics into an additional product that is sold to marketing research firms. One skilled in the art will understand that these are merely a few examples of how the collected statistics may be used and that other possibilities exist.

Action 950 illustrates that the collected statistics may utilized in a way, such as, for example, to increase sales of existing products, or the sale of new products, to offset the cost of the node and the cost of providing access to the first network. These collected statistics may also be used to justify or rationalize the cost of the node to the business' management or other decision makers.

Action 970 illustrates that incentives may be provided in order to encourage a nodelet to support the ad hoc network. In this context, support of the ad hoc network may include actions or services that promote the growth, development and maintenance of the ad hoc network. Such support may include, for example, forwarding packets between the node and other nodelets, providing personal information to the owner of the node, or utilizing the nodelet to allow other nodelets to join the ad hoc network. One skilled in the art will understand that these are a few non-limiting examples and that a number of techniques or actions which support the ad hoc network may be conceived.

Action 990 illustrate an example of an incentive that may be used to encourage actions which support the ad hoc network. The business may provide a number of incentives to nodelets with a positive history of supporting the ad hoc network, such as, for example, giving priority network access the nodelets, giving users of the nodelets coupons for products or services, or transmitting marketing promotions regarding products or services to the nodelet, or giving the user of the nodelet cash, or a substantially equivalent form of credit, that may be used for the purchase of products or services. A specific example of such an incentive may include giving frequent flyer miles to a user that supports the creation of an ad hoc network at an airline's airport terminal. One skilled in the art will realize that other forms of substantially cash equivalent credits may be utilized. Of course, one skilled in the art will understand that other incentives may be used.

Action 980 illustrates that the ad hoc network may provide increased security to packets transmitted via the network. One skilled in the art will realize that many techniques for providing security are known. One skilled in the art will also understand that such security may be used to provide private communication between the node and a nodelet.

The techniques described herein are not limited to any particular hardware or software configuration; they may find applicability in any computing or processing environment. The techniques may be implemented in hardware, software or a combination of the two. The techniques may be implemented in programs executing on programmable machines such as mobile or stationary computers, personal digital assistants, and similar devices that each include a processor, a storage medium readable by the processor (including volatile and non-volatile memory and/or storage elements), at least one input device, and one or more output devices. Program code is applied to the data entered using the input device to perform the functions described and to generate output information. The output information may be applied to one or more output devices.

Each program may be implemented in a high level procedural or object oriented programming language to communicate with a processing system. However, programs may be implemented in assembly or machine language, if desired. In any case, the language may be compiled or interpreted.

Each such program may be stored on a storage medium or device, e.g. compact read only memory (CD-ROM), digital versatile disk (DVD), hard disk, magnetic disk or similar medium or device, that is readable by a general or special purpose programmable machine for configuring and operating the machine when the storage medium or device is read by the computer to perform the procedures described herein. The system may also be considered to be implemented as a machine-readable storage medium, configured with a program, where the storage medium so configured causes a machine to operate in a specific manner. Other embodiments are within the scope of the following claims.

While certain features of the claimed subject matter have been illustrated and described herein, many modifications, substitutions, changes, and equivalents will now occur to those skilled in the art. It is, therefore, to be understood that the appended claims are intended to cover all such modifications and changes that fall within the true spirit of the claimed subject matter.

What is claimed is:

1: A method comprising:
receiving a discovery broadcast from a first nodelet, which is in communication with a node;
determining if communication with the node, via the first nodelet, is desired; and if so,
establishing communication with the node, via the first nodelet, which includes:
utilizing a substantially wireless communication protocol.

2: The method of claim 1, wherein utilizing a substantially wireless communication protocol includes utilizing at least one wireless communications protocol selected from the following:
a wireless protocol involving at least one radio frequency, and
a wireless protocol involving at least one infrared frequency.

3: The method of claim 2, wherein utilizing a substantially wireless protocol involving at least one radio frequency includes utilizing at least one protocol selected from the following:
a protocol substantially in compliance with any of the IEEE 802.11 family of specifications,
a protocol substantially in compliance with an ultra wide band protocol;
a protocol substantially in compliance with those used substantially for cellular telephone communication, and
a protocol substantially in compliance with the Bluetooth specification.

4: The method of claim 1, wherein establishing communication with the node via the first nodelet includes a communication protocol that incorporates security features.

5: The method of claim 1, wherein establishing communication with the node via the first nodelet includes establishing communication with the node via the first nodelet and at least one additional intervening nodelet.

6: The method of claim 1, further comprising:
being in communication with the node, via a second nodelet; and
wherein determining if communication with the node, via the first nodelet, is desired includes determining if communication, via the first nodelet, is preferred over communication, via the second nodelet.

7: The method of claim 6, wherein determining if communication via the first nodelet is preferred over communication via the second nodelet includes preferring one nodelet over the other based upon at least one of the following criteria:
the signal strength of the discovery broadcast,
the communication range of the respective nodelets,
the remaining battery life of the respective nodelets;
the number of intervening nodelets associated with the respective nodelets, and
the network throughput associated with the respective nodelets.

8: The method of claim 1, further comprising:
transmitting a discovery broadcast upon establishing communication with the node via the first nodelet.

9: A method of establishing communication with a node, via a first nodelet, comprising:
a first nodelet establishing communication with a node;
a first nodelet detecting a trigger; and
a first nodelet transmitting a discovery broadcast which
is capable of being received by a second nodelet, and includes utilizing a substantially wireless communication protocol.

10: The method of claim 9 wherein a first nodelet establishing communication with a node includes the first nodelet establishing communication with the node via at least one intervening nodelet.

11: The method of claim 9 wherein the discovery broadcast includes at least one of the following:
the number of intervening nodelets in the chain of communication to the node,
the throughput of the communication with the node,
a quality of service marker related to the communication with the node, and
a unique identifier related to the nodelet.

12: The method of claim 9 wherein detecting a trigger includes at least one of the following:
a timer reaching a certain value,
input data from a user,
receipt of a rediscovery request,
the throughput of the communication with the node, and
the number of intervening nodelets in the chain of communication to the node.

13: A method of communicating between a destination nodelet and a node comprising
detecting a request to forward a packet,
wherein the request includes utilizing a substantially wireless communication protocol;
determining whether the packet is to be forwarded to either to a node or a destination nodelet; and
forwarding the packet towards either the node or the destination nodelet, respectively,
wherein the forwarding includes utilizing a substantially wireless communication protocol.

14: The method of claim 13 further comprising
determining if there is at least one intervening nodelet, and, if so,
wherein, forwarding the packet to either the node or the destination nodelet, respectively, includes forwarding the packet to an intervening nodelet.

15: A system comprising:
a node, which is capable of, during operation, providing access to a network; and
at least one nodelet;
wherein the node and the at least one nodelet are capable of, during operation, being in communication with one another via an intervening nodelet.

16: The system of claim 15 wherein the at least one nodelet is capable of, during operation, establishing communication with the node after receiving a discovery broadcast.

17: The system of claim 16 wherein the discovery broadcast is transmitted by either the node or at least one intervening nodelet.

18: The system of claim 15 wherein the node and the at least one nodelet are capable of, during operation, being in communication with one another at least in part due to a substantially wireless communication protocol.

19: The system of claim 18 wherein the node and the at least one nodelet are capable of, during operation, being in communication with one another at least in part due to a substantially wireless protocol involving at least one radio frequency spectrum including at least one protocol selected from the following:
a protocol substantially in compliance with any of the IEEE 802.11 family of specifications,
a protocol substantially in compliance with an ultra wide band protocol;
a protocol substantially in compliance with those used substantially for cellular telephone communication, and
a protocol substantially in compliance with the Bluetooth specification.

20: The system of claim 15 further comprising
at least a first intervening nodelet; and
wherein the at least a first intervening nodelet is capable of, during operation, forwarding packets from the at least one nodelet to the node.

21: The system of claim 20 wherein the at least a first intervening nodelet is capable of, during operation, forwarding packets from the node to the at least one nodelet.

22: The system of claim 21 further comprising
at least a second intervening nodelet; and
wherein the at least a first intervening node is capable of, during operation, forwarding packets from the node to the at least one nodelet, or vice versa, via the at least a second intervening nodelet.

23: An apparatus comprising:
a nodelet, including:
a transmitter,
a receiver, and
a communications processing system;
wherein the transmitter, the receiver, and the communications processing system are coupled so as to be capable of, during operation,
receiving a discovery broadcast, and
establishing communication with a node via an intervening nodelet;
wherein communication between the nodelet and the node is at least in part due to a substantially wireless communication protocol.

24: The apparatus of claim 23 wherein the discovery broadcast is transmitted by at least one of the node and at least one intervening nodelet.

25: The apparatus of claim 23 wherein the node and the at least one nodelet are capable of, during operation, being in communication with one another at least in part due to a substantially wireless protocol involving at least one radio frequency spectrum including at least one protocol selected from the following:
a protocol substantially in compliance with any of the IEEE 802.11 family of specifications,
a protocol substantially in compliance with an ultra wide band protocol;
a protocol substantially in compliance with those used substantially for cellular telephone communication, and
a protocol substantially in compliance with the Bluetooth specification.

26: The apparatus of claim 23 wherein the nodelet comprises a device selected from the following: a notebook computer, cellular telephone, handheld computer, personal digital assistant, media player, and a mobile computer.

27: An apparatus comprising
a nodelet, including:
a transmitter,
a receiver, and
a communications processing system;
wherein the transmitter, the receiver, and the communications processing system are coupled so as to be capable of, during operation,
being in communication with a node and at least one other nodelet, and
forwarding a packet from the at least one other nodelet to the node;
wherein communication between the nodelet and the node is at least in part due to a substantially wireless communication protocol.

28: The apparatus of claim 27 wherein the nodelet is capable of, during operation, forwarding a packet from the node to the at least one other nodelet.

29: The apparatus of claim 27 wherein the nodelet is capable of, during operation,
being in communication with a node via a first intervening nodelet and,
upon receiving a discovery broadcast from a second intervening nodelet, is capable of, during operation,
establishing communication with the node via the second intervening nodelet.

30: The apparatus of claim 29 wherein the nodelet is capable of, during operation,
determining whether to establish communication with the node via the second intervening nodelet at least partially based upon at least one of the following factors:
the signal strength of the discovery broadcast,
the communication range of the second intervening nodelet,
the quality of service associated with the second intervening nodelet,
the remaining battery life associated with the second intervening nodelet,
the number of intervening nodelets associated with the second intervening nodelet, and
the network throughput associated with the second intervening nodelet.

31: The apparatus of claim 27 wherein the nodelet is capable of, during operation, transmitting a discovery broadcast.

32: The apparatus of claim 31 wherein the discovery broadcast includes at least one of the following:
the number of intervening nodelets in the chain of communication to the node,
the throughput communication between the node and the nodelet,
a quality of service marker related to communication between the node and the nodelet, and
a unique identifier related to the nodelet.

33: The apparatus of claim 27 wherein the nodelet is capable of, during operation, requesting that an intervening nodelet forward a packet to the node.

34: The apparatus of claim 27 wherein the nodelet comprises a device selected of the following: a notebook computer, cellular telephone, handheld computer, personal digital assistant, media player and a mobile computer.

35: An article comprising:
a storage medium having a plurality of machine accessible instructions, wherein when the instructions are executed by a processor, the instructions provide for
receiving a discovery broadcast from a first nodelet, which is in communication with a node;
determining if communication with the node, via the first nodelet, is desired; and, if so,
establishing communication with the node, via the first nodelet, which includes:
utilizing a substantially wireless communication protocol.

36: The article of claim 35, wherein instructions for utilizing a substantially wireless communication protocol includes instructions for utilizing at least one wireless communications protocol selected from the following list:
a wireless protocol involving at least one frequency within the radio spectrum, and
a wireless protocol involving at least one frequency within the infrared spectrum.

37: The article of claim 35, wherein instructions for utilizing a substantially wireless protocol involving signals at a frequency within the radio spectrum includes instructions for utilizing at least one protocol selected from the following:
a protocol substantially in compliance with any of the IEEE 802.11 family of specifications,
a protocol substantially in compliance with an ultra wide band protocol;
a protocol substantially in compliance with those used substantially for cellular telephone communication, and
a protocol substantially in compliance with the Bluetooth specification.

38: The article of claim 35, wherein instructions for establishing communication with the node, via the first nodelet, includes instructions for using a communication protocol that incorporates security features.

39: The article of claim 35, wherein instructions for establishing communication with the node, via the first nodelet, includes instructions for establishing communication with the node, via the first nodelet and at least one additional intervening nodelet.

40: The article of claim 35, further comprising instructions for
being in communication with the node, via a second nodelet; and
wherein determining if communication with the node, via the first nodelet, is desired includes determining if communication, via the first nodelet, is preferred over communication, via the second nodelet.

41: The article of claim 40, wherein instructions for determining if communication via the first nodelet is preferred over communication via the second nodelet includes instructions for preferring one nodelet over another based upon at least one of the following criteria:
the signal strength of the discovery broadcast,
the communication range of the respective nodelets,
the quality of service associated with the respective nodelets,
the remaining battery life of the respective nodelets,
the number of intervening nodelets associated with the respective nodelets, and
the network throughput associated with the respective nodelets.

42: The article of claim 35, further comprising instructions for
transmitting a discovery broadcast upon establishing communication with the node, via the first nodelet.

43: An article comprising:
a storage medium having a plurality of machine accessible instructions, wherein when the instructions are executed by a processor, the instructions provide for
a first nodelet establishing communication with a node;
a first nodelet detecting a trigger; and
a first nodelet transmitting a discovery broadcast which
is capable of being received by a second nodelet, and includes utilizing a substantially wireless communication protocol.

44: The article of claim 43 wherein instructions for establishing communication with a node includes instructions for establishing communication with a node via at least one intervening nodelet.

45: The article of claim 43 wherein the discovery broadcast includes at least one piece of information selected from the following:
the number of intervening nodelets in the chain of communication to the node,
the throughput of the communication with the node,
a quality of service marker related to the communication with the node, and
a unique identifier related to the nodelet.

46: An article comprising:
a storage medium having a plurality of machine accessible instructions, wherein when the instructions are executed by a processor, the instructions provide for
detecting a request to forward a packet,
wherein the request includes utilizing a substantially wireless communication protocol;
determining whether the packet is to be forwarded to either to a node or a destination nodelet; and
forwarding the packet towards either the node or the destination nodelet, respectively,
wherein the forwarding includes utilizing a substantially wireless communication protocol.

47: The article of claim 46 further comprising instructions for
determining if there is at least one intervening nodelet, and, if so,
wherein comprising forwarding the packet to either the node or the destination nodelet, respectively, includes forwarding the packet to an intervening nodelet.

48: A method comprising:
establishing a node capable of, during operation, accessing a first network;
utilizing the node to route packets between the first network and an ad hoc network, which is established, at least in part, by utilizing nodelets; and
communicating that better network access may be achieved by bringing a nodelet within at least a certain range of the node.

49: The method of claim 48, further comprising collecting statistics on usage of the ad hoc network, by a nodelet.

50: The method of claim 49, wherein collecting statistics on usage of the ad hoc network, by a nodelet, includes collecting at least one of the following data:
the amount of time spent by a nodelet within a certain range,
the marketing demographics of the user of the nodelet,
the content accessed by the nodelet,
the actions taken by the nodelet for the promotion of the growth, development and maintenance of the ad hoc network, and
the location of the nodelet.

51: The method of claim 50, further comprising utilizing the collected statistics to offset the cost of the node and the cost of accessing the first network.

52: The method of claim 49, further comprising adjusting advertising based, at least in part, upon the collected statistics.

53: The method of claim 49, further comprising selling advertising utilizing, at least in part, the collected statistics.

54: The method of claim 48, further comprising providing an incentive for a nodelet to take actions which promote the growth, development, and maintenance of the ad hoc network.

55: The method of claim 54, wherein providing an incentive for a nodelet to take actions which promote the growth, development, and maintenance of the ad hoc network includes at least one of:
giving priority network access to nodelets with a history of taking actions which promote the growth, development, and maintenance of the ad hoc network,
giving the user of the nodelets cash or a substantially equivalent form of credit that may be used for the purchase of products and services,
giving the users of the nodelets coupons for products and services, and
transmitting marketing promotions regarding products and services to the nodelet.

56: The method of claim 54, wherein taking actions which promote the growth, development, and maintenance of the ad hoc network includes at least one of:
forwarding packets between the node and other nodelets,
providing personal information to the owner of the node, and
utilizing the nodelet to allow other nodelets to join the ad hoc network.

57: The method of claim 48, further comprising transmitting packets, via the ad hoc network, in a secure manner.
